(19) United States
(12) Patent Application Publication
(10) Pub. No.: US 2024/0051209 A1
(43) Pub. Date: Feb. 15, 2024

(54) Injection Mold

(71) Applicant: Otto Männer GmbH, Bahlingen a. K. (DE)

(72) Inventor: Christian Slisse, Rixheim (FR)

(73) Assignee: Otto Männer GmbH, Bahlingen a.K. (DE)

(21) Appl. No.: 18/268,264

(22) PCT Filed: Dec. 22, 2021
(86) PCT No.: PCT/EP2021/087195

§ 371 Date: Jun. 19, 2023

(30) Foreign Application Priority Data
Dec. 22, 2020 (DE) 10 2020 134 762.6

(51) Int. Cl. B29C 45/84

(52) U.S. Cl. CPC B29C 45/84; B29C 2045/1796

(57) ABSTRACT

The disclosure is related to an injection mold suitable to be arranged in and during operation interconnected to an injection molding machine for injection molding of plastic parts. The injection mold typically includes at least one sensor and a tamper evident safeguarding assembly for safeguarding of the injection mold. Safeguarding assembly usually includes an electronic circuit interconnected to the at least one sensor and configured to detect at least one critical injection mold condition based on at least one predetermined condition, and a disrupting device interconnected to the electronic circuit and configured to at least temporarily disrupt directly and/or indirectly the operation of the injection mold.

### CROSS-REFERENCE TO RELATED APPLICATIONS

This application is a U.S. National Stage Application that claims the benefit of the filing date of International PCT Application No. PCT/EP2021/087195, filed on Dec. 22, 2021, that in turn claims priority to German Patent Application No DE102020134762.6, filed on Dec. 22, 2020, that are hereby incorporated by reference in their entirety.

### FIELD

The present disclosure is directed towards the field of injection molding of plastics and other thermoplastic materials. More particularly it is directed towards an injection mold comprising a safeguarding device for protecting the injection mold.

### BACKGROUND

From the prior art injection molds having limited safety capabilities are known.

US2016332350A1 published in November 2016 in the name of Inglass SPA relates to a method for managing an apparatus for the injection molding of plastic materials. The apparatus comprises at least one injector including a pin valve displaceable between a fully closed position and an open position of the injector, an actuator for operating the pin valve of the injector, and an electronic control unit of the actuator. The method provides for the steps of providing an auxiliary power supply and configuring said electronic control unit so as to operate, in case of failure of the mains power supply, an emergency command by virtue of which the pin valve of the injector is positioned in said fully closed position by means of said auxiliary power supply.

U.S. Ser. No. 10/525,626B2 published in January 2020 in the name of Imflux Inc. relates to methods of monitoring and controlling a molding process using a sensed change in strain provided by a strain gauge. A target strain profile is created for a molding process of a molding apparatus. An upper and lower deviation limit from the target strain profile for the molding process is provided. If a sensed change in strain exceeds a deviation limit, an alarm is activated.

### SUMMARY

Injection molds as known from the prior art have several disadvantages facing a globalized and increasingly digitally interconnected industry. This is for example particularly the case when the owner of the costly injection mold hands it over for use to a third party e.g. a contract manufacturer. Here it is vital to the owner of the injection mold that it is used properly, meaning inter alia staying within the predefined ranges for the process parameters during operation. Furthermore, maintenance and/or repair procedures of the injection mold should be properly carried out as predefined and/or indicated. In other words, an improper use of the injection mold should be detected, respectively predicted and if necessary prevented.

A first aspect of the disclosure is directed to an injection mold typically comprising a first mold half and a second mold half during operation arranged movably with respect to each other between an open position and a closed position. The first mold half and the second mold half usually form in the closed position at least one cavity suitable to receive melted plastic. It should be understood that more complex injection molds comprising more than two mold halves form part of this disclosure as well, in particular cube molds.

Good results can be achieved, when the injection mold comprises at least one sensor. The at least one sensor is preferably connected to a tamper evident safeguarding assembly for safeguarding of the injection mold. The tamper evident safeguarding assembly can be at least partially attached to and/or incorporated in at least one of the mold halves. The at least one sensor can typically be at least one out of the following: a temperature sensor, a (melt or cavity) pressure sensor, a proximity or contact sensor, an optical sensor, an acoustic sensor or an acceleration sensor. Depending on the field of application the injection mold may comprise multiple sensors, in particular a combination of the aforementioned types of sensors. Preferably the safeguarding assembly can safeguard the injection mold in an autonomous manner, in particular without a need for external supervision, however if appropriate the safeguarding assembly may be configured to receive external inputs.

In general, the tamper evident safeguarding assembly comprises an electronic circuit interconnected to the at least one sensor and configured to detect, respectively predict at least one critical injection mold condition based on at least one predetermined condition. To allow an independent safeguarding of the injection mold, a disrupting device is interconnected to the electronic circuit and configured to at least temporarily disrupt directly and/or indirectly the operation of the injection mold. This way the abilities of the injection mold are extended beyond the mere monitoring and comprise in addition the effective safeguarding. Preferably the electronic circuit is configured to actuate upon detection, respectively prediction of a critical injection mold condition the disrupting device. The disrupting device as well as the electronic circuit, is described in more detail further below.

The electronic circuit typically has a centralized topology, wherein one or more sensors of the injection mold are respectively interconnected to the electronic circuit. However, a distributed topology is thinkable as well, with at least one electronic sub-circuit interconnected to one or more sensors, the electronic sub-circuit being configured to detect at least one critical injection mold condition based on at least one predetermined condition. The at least one sub-circuit is preferably interconnected to the (main) electronic circuit for providing data related to the condition of the injection mold to the (main) electronic circuit.

Preferably the electronic circuit is arranged in a housing attached to and/or incorporated in the injection mold. If appropriate the housing can be attached to an outside of the injection mold. In some variations, the housing of the electronic circuit may form part of a cable connection box of the injection mold, as well.

Good results are possible when the housing is tamper evident, such that unauthorized access to the electronic circuit is detectable. If desired, the electronic circuit can be configured to actuate the disrupting device upon detection of an unauthorized access. Depending on the design, an electrical tamper detection circuit interconnected to the electronic circuit may be arranged at or incorporated into the housing. The electrical tamper detection circuit can be formed as sensor e.g. a contact sensor or distance sensor, however other implementations are thinkable. The electronic circuit can monitor the electrical tamper detection circuit to detect a disturbance and thus an unauthorized access to the housing. A disturbance may in particular be caused by opening the housing. Upon detection of a disturbance of the electrical tamper detection circuit, the electronic circuit may actuate the disrupting device. To allow for maintenance by authorized personnel, the electronic circuit can be configured to receive an input from a thereto interconnected input device to at least temporarily not actuate the disrupting device, in particular when a disturbance of the tamper detection circuit is detected. Upon validation in the electronic circuit of the received input, such as an access code, the electronic circuit may temporarily disregard a disturbance of the tamper detection circuit.

Alternatively or in addition, the housing and/or its attachment means for attaching the housing to the injection mold can be tamper resistant. This can be achieved by using e.g. tamper-resistant screws with special screw heads, such that they can only be removed with particular tools. Typically, these tools are only available to authorized personnel.

For further tamper prevention the disrupting device is preferably configured to self-actuate when disconnected from the electronic circuit. This way the safeguarding of the injection mold can be ensured in an autonomous manner.

In order to efficiently safeguard the injection mold the disrupting device is preferably configured to interrupt a supply of the injection mold. This supply can in particular be at least one out of the following: a hydraulic supply, a pneumatic supply, an electrical supply or a melted plastic supply. Accordingly, the disrupting device can in particular be formed as a valve, a switch or an actuator or a combination thereof. The supply which can be interrupted by the disrupting device preferably is a supply essential to the operation of the injection mold. Depending on the implementation the disrupting device can comprise an actuator and a thereto connected valve at least temporarily controlled by the actuator. The actuator is in turn preferably connected to the electronic circuit and configured to open or close the valve.

Alternatively or in addition, the disrupting may interrupt an externally monitored process variable of the injection mold. In particular, the disrupting device can be configured to manipulate sensor data transmitted from a sensor arranged in or at the injection mold to a thereto connected external electronic circuit enabling the external electronic circuit based on the manipulated sensor data to at least temporarily prevent operation of the injection mold and/or the injection molding machine. In other words the disrupting device may manipulate the sensor data, such as to cause a (simulated/virtual) fault of the injection mold, detectable by the external electronic circuit. Alternatively or in addition, the disrupting device may be configured to transmit a break/stop operation signal to a thereto connected external electronic circuit. The external electronic circuit can in particular form part of the injection molding machine and/or at least one process controller.

In a preferred variation the electronic circuit can act as the disrupting device. This allows for a simple design of the safeguarding assembly and an easy retrofittability for injection molds known from the prior art.

A second aspect of the disclosure is directed to the electronic circuit for monitoring of at least one condition of the injection, the electronic circuit typically comprises at least one processor. The electronic circuit described herein can also be used with injection molds, which are not described herein. For this reason, the applicant reserves the right to pursue this aspect separately in one or more divisional applications.

The at least one processor of the electronic circuit is preferably configured to determine at least one time interval. The determined at least one time interval can be measured between receipt of two definable sensor data points. Alternatively or in addition, the determined at least one time interval can be measured between two or more definable inputs received from an input device connected to the electronic circuit. If appropriate the at least one time interval can be used to validate in the processor if a certain repair or maintenance procedure was executed. The at least one time interval can be at least one out of the following: a downtime, a cycle duration or the time between two (specific) input value received from an input device connected to the electronic circuit e.g. relating to a (specific) maintenance/repair time period.

Depending on the required computational efforts, the at least one processor can be a microprocessor, such as an ASIC (application-specific integrated circuit) or an FPGA (field-programmable gate array), however a general purpose computing unit such as CPU (central processing unit) or a combination therewith is thinkable.

For good performance the electronic circuit can comprise at least one memory configured to store at least temporarily
sensor data received from the at least one sensor and/or
at least one time interval and/or
at least one input value received from an input device connected to the electronic circuit and/or
a value derived from the sensor data and/or the at least one time interval and/or
the at least one input value and/or
a combination thereof.

The at least one processor is in this case preferably configured to detect a critical condition of the injection mold based at least partially on data stored in the memory. This allows the at least one processor to detect a critical condition of the injection mold based on stored data, in particular including measured historic data. The input device can be formed as a keyboard or the like, however optical or close range radio interfaces, such as QR code scanner or RFID scanners, or a combination thereof are possible as well.

In a variation the at least one processor is configured to adapt the at least one predetermined condition based on historic data stored in the at least one memory. This allows for example to take into account the aging of the injection mold and to adapt the predetermined condition accordingly.

Depending on the application the at least one memory is configured to store reference data of the at least one predetermined condition. The reference data can be understood as the criteria for the at least one predetermined condition. The reference data may comprise at least one threshold value and/or at least one comparison value. The at least one processor is in this case preferably configured to determine if at least one out of the following (see below), is above or below the at least one threshold value and/or mismatching with a comparison value, each the threshold value and the comparison value respectively defining a critical injection mold condition:
the sensor data received from the at least one sensor and/or
the at least one time interval and/or at least one input value received from an input device connected to the electronic circuit and/or
a value derived from the sensor data and/or
the at least one time interval and/or
the at least one input value and/or
a combination thereof.

The at least one threshold value can be a fixed value such as an upper temperature limit, however the threshold value is not limited to fixed values and may e.g. include a limit on the variance of a temperature profile (a set temperature sensor data points) with respect to a reference temperature profile. The at least one threshold value may also define a limit for derived or relative values, such as for example a limit for the deviation of two simultaneously measured values of two sensors. The comparison value can for example be, but not limited to, a part identification (ID) of spare parts for installation in the injection mold. The part ID can be entered via the input device configured to transmit the part ID to the thereto connected processor, such that the processor is enabled to compare the part ID to reference data in order to verify the conformity of the spare part. This way it can be ensured that during repair and/or maintenance of the injection mold the correct parts and/or parts from a known origin satisfying quality standards are installed.

For a granular monitoring the injection mold comprises at least one exchangeable part having a part identification (ID) and the electronic circuit being configured to store the part identification of the at least one exchangeable part and to detect at least one critical injection mold condition based on at least one definable critical condition of the at least one exchangeable part. The injection mold in this case is a multi-part injection mold. The at least one exchangeable part can be at least on out of the following: a cavity block, a cavity plate, a cavity insert, a slider, a sensor, a hot-runner segment or nozzles. Typically, the performance/condition of the injection mold depends on the performance/condition of the at least one exchangeable part. This part may be subject to wear and therefore requires periodic maintenance. The part ID can for example be implemented as an engraved identification on the exchangeable part.

In a preferred variation the at least one exchangeable part comprises an information carrier having stored thereon at least the part identification readable by an input device being connected to the electronic circuit. The information carrier can be implemented as a QR code, a bar code, a RFID tag, a NFC tag (Near Field Communication), a Bluetooth beacon, a memory device interconnectable via wire to the electronic circuit. In addition, the information carrier may have stored thereon at one out of the following: threshold data defining a critical condition of the at least one exchangeable part, historic data relating to the use of the at least one exchangeable part, molding recipe data for the exchangeable part or a combination thereof.

The input device can be configured to obtain the part identification from the exchangeable part in an automated, semi-automated or manual manner forward it to the electronic circuit. Manuel can be understood in this context in that the input device receives the part identification as a manual input e.g. as a keyboard input from a user. Automated can be understood in that the input device is configured to read the part identification from the exchangeable part when it is installed in the injection mold without the need of a user interaction. Semi-automatic usually refers to the input device reading the part identification from the exchangeable part when the part is presented thereto or within a reading range of the input device.

Good results are possible, when the electronic circuit is configured to determine a critical condition of the at least one exchangeable part based at least partially on data received from the at least one sensor. This allows to determine the condition of the at least one exchangeable part, in particular during operation. Preferably, the data received in the electronic circuit from the at least one sensor relates to at least one out of the following: an operating temperature of the at least one exchangeable part or a cycle count of the injection mold, preferably of the at least one exchangeable part. However, other data received from the at least one sensor is possible, depending on the type of sensor, such as pressure data, proximity data etc.

To allow an anticipatory operation of the injection mold the electronic circuit may comprise at least one communication unit configured to transmit an analysis request comprising data related to at least one condition of the injection mold to a computer system via a communication network, enabling the computer system to obtain an injection mold analysis at least partially based on the data of the analysis request and to transmit the injection mold analysis for display to a visual user interface. Alternatively or in addition, the processor can be configured to obtain an injection mold analysis as well. Preferably the processor can transmit the injection mold analysis to a visual user interface for display.

Depending on the design, the electronic circuit can comprise a location module to determine the location of the injection mold within a production and/or storage area, in particular in relation to the injection molding machine. Preferably the analysis request further comprises the location of the injection mold, in particular geolocation data, such as GPS coordinates.

If appropriate, the electronic circuit may be configured to receive data related at least to the operation from the injection molding machine. The analysis request may in this case further comprise at least part of the data received from the injection molding machine.

In a preferred variation, the electronic circuit is configured to trigger an alarm if disconnected from the disrupting device. In particular, the communication unit can be configured to transmit an alarm message to the computer system via a communication network, enabling the computer system to process and/or transmit the alarm message for display to the visual user interface.

For easy use, the visual user interface is advantageously designed as a user-interactive dashboard accessible by the operator via a user device such as a mobile phone, a tablet or a laptop connected via the communication network to the computer system. However, as indicated above and described further below, the electronic circuit can be connected directly to the user device and/or the visual user interface. The communication network typically comprises a mobile radio network, such as GSM (Global System for Mobile Communication), UMTS (Universal Mobile Telephone System), 5G, WLAN (Wireless Local Area Network) or the like. However, the communication network can, alternatively or in addition, comprise a wire or cable based network, such as provided by LAN (Local Area Network), an Ethernet connection or an USB connection or the like, and/or the Internet.

If appropriate the injection mold analysis comprises at least one out of the following: at least one condition of the injection mold and/or at least one key performance indicator (KPI) of the injection mold corresponding to at least one out of the following: a value, a goal, a status, a trend and/or a weight. Alternatively or in addition, the at least one communication unit can be configured to receive an analysis response from the computer system via a communication network. The analysis response may comprise at least one condition of the injection mold and/or at least one key performance indicator (KPI) of the injection mold and/or instructions for the disrupting device. Depending on the implementation the analysis response may alternatively or in addition, comprise reference data for updating the reference data stored in the memory of the electronic circuit.

The at least one KPI can be understood, however is not limited to, as a measure for the health (indicating the need for repair and/or maintenance) or the performance (indicating a possibility for improvements of the operation) of the injection mold. The at least one KPI may assist the operator of the injection mold to increase the longevity and/or the efficiency of the injection mold. However, the KPI may as well indicate a proper operation of the injection mold, e.g. how well the predefined repair and/or maintenance procedures and/or predefined operating conditions pf the injection mold are respected.

Depending on the field of application the at least one processor of the electronic circuit is preferably configured to determine at least one key performance indicator (KPI) of the injection mold from data stored in the at least one memory and to provide the at least one KPI for display to a visual user interface connected to the electronic circuit. The visual user interface can be incorporated into a user device, or can be incorporated into the injection molding machine or the injection mold as well. The at least one key performance indicator (KPI) of the injection mold may correspond to a value, a goal, a status, a trend and a weight, as described above.

To simplify and promote an issue minimized operation of the injection mold, the electronic circuit can be configured to trigger, depending on at least one condition of the injection mold, the display of maintenance information on a thereto directly or indirectly connected visual user interface. Preferably the maintenance information is related to potential improvements of the at least one KPI, such as health or performance. The maintenance information may comprise a notification and/or a description of the at least one condition of the injection mold. Alternatively or in addition, the maintenance information can comprise a guide, in particular a visual guide, such as picture or video based instructions, for carrying out a repair and/or maintenance procedure related to the at least one condition of the injection mold. For example, the electronic circuit may trigger the display of a notification that a sensor is faulty and furthermore, provide video instruction on how to replace the faulty sensor for a spare one.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings are showing:

FIG. 1 a first variation of the injection mold;

FIG. 2 a second variation of the injection mold;

FIG. 3 a block diagram of a safeguarding assembly;

FIG. 4 a block diagram of an electronic circuit;

FIG. 5 a schematic illustration of injection molds connected to a computer system and visual user interfaces;

FIG. 6 a timing diagram illustrating an exemplary sequence of steps for transmitting data from an injection mold to a visual user interface; and

FIG. 7 a third variation of the injection mold.

### DETAILED DESCRIPTION

Reference will now be made in detail to certain embodiments, examples of which are illustrated in the accompanying drawings, in which some, but not all features are shown.

Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

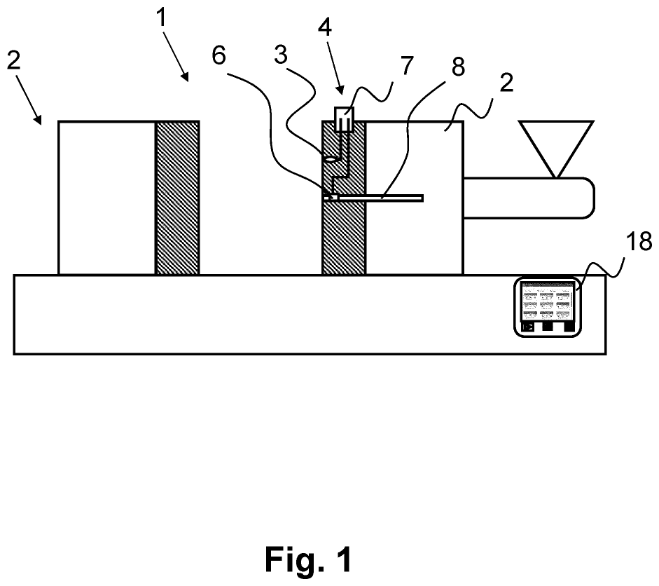

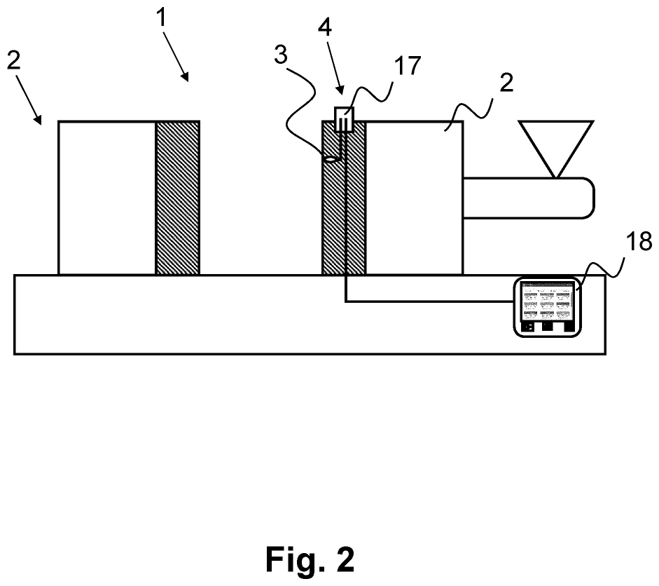

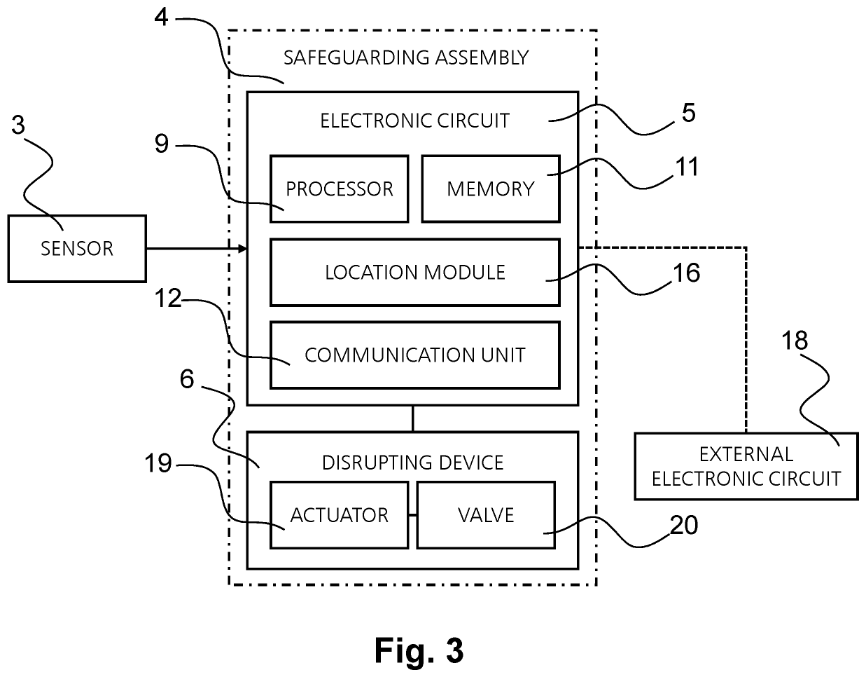

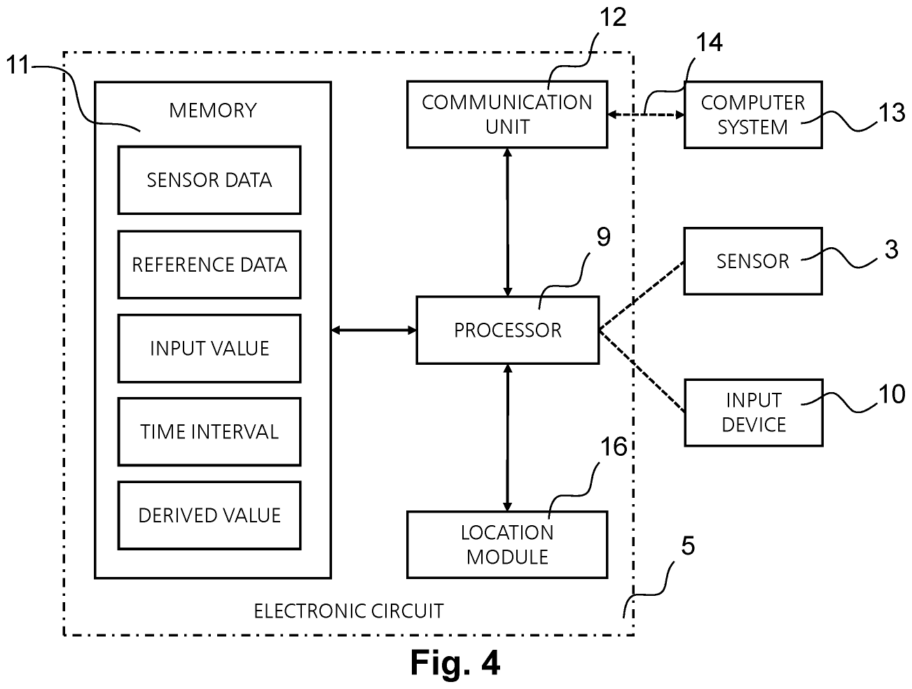

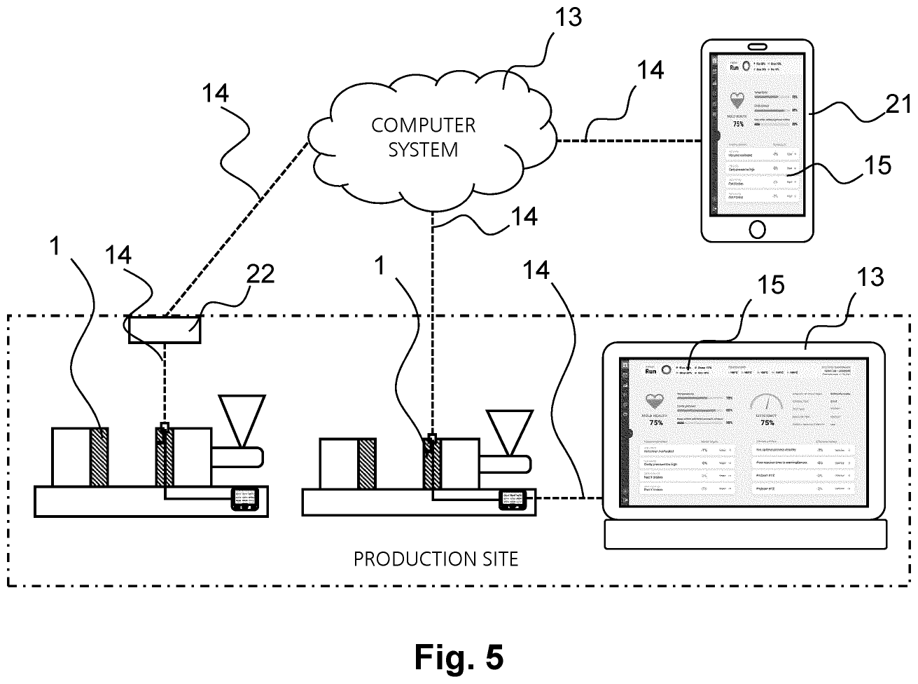

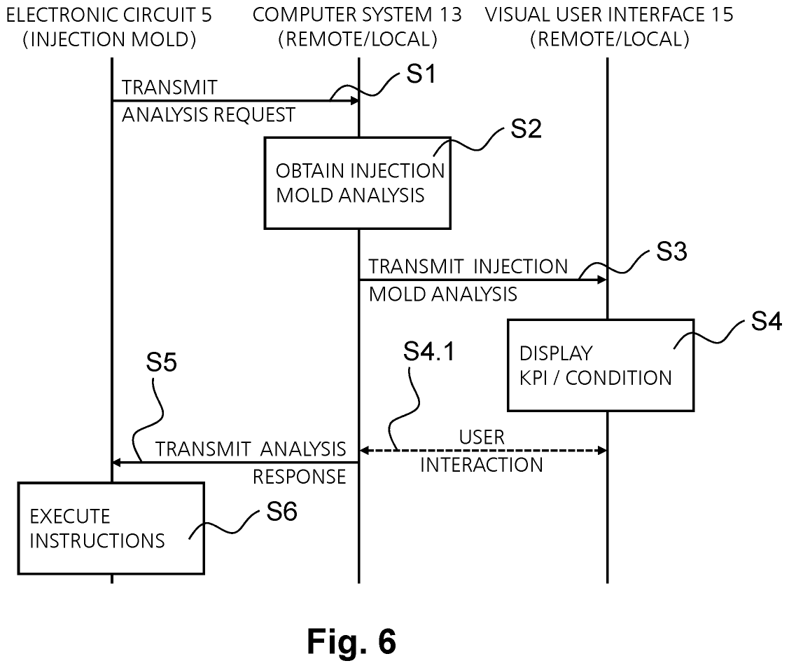

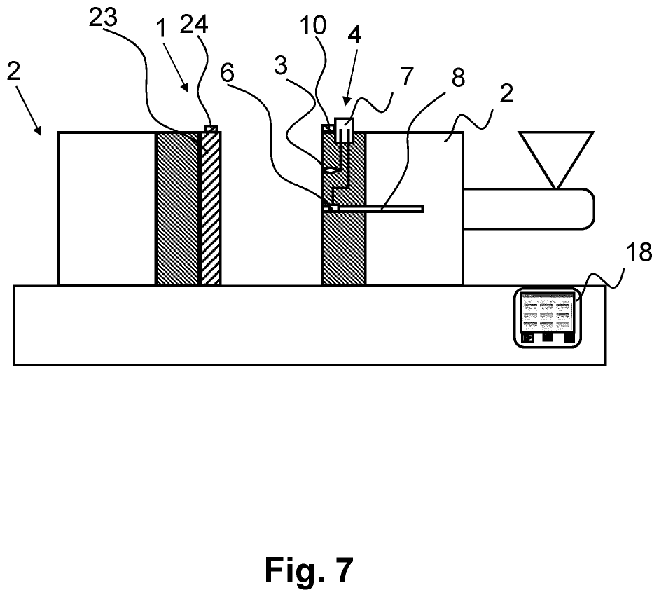

FIG. 1 shows a first variation of the injection mold 1 and FIG. 2 shows a second variation of the injection mold 1. FIG. 3 shows a block diagram a safeguarding assembly 4 and FIG. 4 shows an electronic circuit 5 forming part of the safeguarding assembly 4 of FIG. 3. FIG. 5 shows a schematic illustration of injection molds 1 connected to a computer system 12 and visual user interfaces 15. In FIG. 6 a timing diagram illustrating an exemplary sequence of steps for transmitting data from an injection mold to a visual user interface is shown. FIG. 7 shows a third variation of the injection mold according to the disclosure.

FIGS. 1 and 2 show two variations of injection molds 1 according to the disclosure. FIG. 7 shows a similar third variation. These are respectively shown arranged in an injection molding machine 2. The injection mold 1 comprises in the shown variations a first mold half and a second mold half respectively attached to the injection molding machine 2, such that they are movable during operation with respect to each other between an open position and a closed position. In the closed position the first mold half and the second mold half usually form at least one cavity (not shown) suitable to receive melted plastic to form plastic parts. Both variations of the injection mold 1 comprise at least one sensor 3 interconnected to a tamper evident safeguarding assembly 4 of the injection mold 1 for safeguarding the injection mold 1.

The tamper evident safeguarding assembly 4 usually comprises an electronic circuit 5, interconnected to the at least one sensor 3 and configured to detect at least one critical injection mold condition based on at least one predetermined condition. The electronic circuit 5 is shown in FIGS. 3 and 4 and described in more detail below. For good results, the safeguarding assembly 4 comprises in addition a disrupting device 6 interconnected to the electronic circuit 4 and configured to at least temporarily disrupt directly and/or indirectly the operation of the injection mold 1. The electronic circuit 5 is usually configured to actuate upon detection of a critical injection mold condition the disrupting device 6, thereby safeguarding the injection mold 1 from harmful operating conditions.

As shown in the second variation of the injection mold 1 in FIG. 2, the electronic circuit 5 can be arranged in housing 7, as shown in FIG. 1, attached to the injection mold 1. In this variation (FIG. 2) the housing forms part of a cable connection box 17 of the injection mold 1 for efficient wiring therebetween. This allows a simple connection of the sensor 3 connected to the cable connection box 17 to the electronic circuit 5.

In the first variation, as shown in FIG. 1, the disrupting device 6 is configured to interrupt a supply 8 of the injection mold. The supply 8 can in particular be a hydraulic supply, a pneumatic supply or an electrical supply for controlling the melt flow within the injection mold 1. In the shown variation, the disrupting device 1 comprises an actuator 19 and a thereto connected valve 20 controlled by the actuator 19, wherein the actuator 19 controls the movement of a needle (not shown) for opening and closing of the valve 20. This embodiment of the disrupting device 6 is schematically shown in FIG. 3.

The second variation, as shown in FIG. 2, the disrupting device 6 is incorporated into the electronic circuit 5 and connected to an external electronic circuit 18. The external electronic circuit 18 in this variation forms part of the injection molding machine 2 and is configured to at least temporarily control the operation of the injection molding machine 2. Upon detection of a critical mold condition, the electronic circuit 5 actuates the disrupting device 6, which then can transmit a break/stop operation signal to the external electronic circuit 18. The external electronic circuit 18 is thereby enabled to at least temporarily stop the operation of the injection mold 1. Alternatively or in addition, the disrupting device 6 can manipulate sensor data transmitted from the sensor 3 arranged in or at the injection mold to the thereto connected external electronic circuit 18. This enables the external electronic circuit 18 based on the manipulated sensor data to at least temporarily prevent operation of the injection mold 1 and/or the injection molding machine 2.

FIG. 3 shows a block diagram of the safeguarding assembly 4 comprising the electronic circuit 5 and the disrupting device 6. In addition, the at least one sensor 3 connected to the electronic circuit providing sensor data to the electronic circuit 5 shown. Also the external electronic circuit 18 is shown connected to the electronic circuit 5. Once the electronic circuit 5 detects a critical injection mold condition the disrupting device 6 can depending on the variation, interrupt a supply 8 controlled by the valve 20 or trigger a stop of the operation of the injection mold machine 2 via the external electronic circuit 18.

In FIG. 4 a block diagram of the electronic circuit 5 and the thereto connected computer system 13, input device 10 and sensor 3, is visible. The shown variation of the electronic circuit 5 comprises a processor 9, a memory 11, a communication unit 12 and a location module 16. The processor 9 is typically configured to interact with the shown components of the electronic circuit 5 respectively, however a direct interaction between the components of the electronic circuit 5 is possible as well. The communication device is preferably configured to communicate with the (remote) computer system via a communication network 14 and in particular to transmit analysis request to the computer system 13 and to receive analysis responses therefrom.

FIG. 5 shows a schematic illustration of a production site comprising at least one injection mold 1 connected to a computer system 13, in the shown case there are two injection molds 1 respectively arranged in an injection molding machine. One of the injection molds 1 (right one in FIG. 5) is connected to a local computer system 13 via a local communication network 14, such as LAN-, USB-, WiFi- or Bluetooth-connection. In this embodiment a visual user interface 15 is incorporated into the local computer system 13. In addition, the same injection mold 1 is connected to a remote computer system 13 via the same or another communication network 14, such as GSM or the internet. The second visual user interface 15 forms part of a user device 21 connected to the remote computer system 13. The second injection mold 1 (left one in FIG. 5) is indirectly connected to the remote computer system 13 via a local gateway 22 connectable to multiple injection molds 1. The electronic circuit 5 is usually configured to communicate with one or more local gateways 22. The local gateway 22 can forward data received from the injection mold 1 to the computer system 13 (remote/local) and vice versa.

In FIG. 6 exemplary steps are shown relating to the communication between the electronic circuit 5 and computer system 13, and indirectly with a visual user interface 15. The communication unit 12 of the electronic circuit 5 is preferably configured to transmit S1 an analysis request to the computer system 13. The analysis request typically comprises at least data related to at least one condition of the injection mold. This data can be, but not limited to, a cycle count data, pressure or temperature data, error code data, a spare part ID data, location data, downtime data or authentication data or the like. The computer system 13 is thereby enabled, to obtain S2 an injection mold analysis based on the received data, the analysis comprising at least one KPI. Furthermore, the injection mold 1 analysis may comprise maintenance information relating to the at least one condition of the injection mold 2 and improvements thereof. The computer system 13 may use historic data of injection mold conditions and machine learning methods to improve the injection mold analysis in particular the accuracy.

In the shown example the computer system 13 transmits S3 the injection mold analysis at least in part for display to the visual user interface 15. Upon receipt of the at least a partial injection mold analysis the visual user interface 15 can display S4 for example a KPI or a condition of the injection mold 1. The visual user interface 15 is typically implemented as a user-interactive visual user interface 15 and configured to display information upon request by the user. If appropriate the visual user interface 15 is configured to communicate with the computer system 13 to request S4.1 additional data from the computer system 13 and to display the additional data upon receipt S4.1 from the computer system 13.

In step S5, as shown in FIG. 6, the communication unit 12 can be further configured to receive S5 an analysis response from the computer system 13 via a communication network 14. The analysis response can comprise inter alia instructions for the electronic circuit 5 depending on the condition of the injection mold 1 and therefore the injection mold analysis. For example, if the computer system 13 obtains an injection mold analysis indicating an undesired mold condition the instructions can be to actuate the disrupting device 6. In this case the electronic circuit 5 is enabled to execute S6 the instructions and actuate the disrupting device 6 in order to at least temporarily stop the operation of the injection mold 1.

The third variation of the injection mold, as shown in FIG. 7, comprises an exchangeable part 23. The exchangeable part 12 is removably attached to the injection mold 1. Attached to the exchangeable part 23 is an information carrier 24. The information carrier 24 is configured to store a part identification for identifying the exchangeable part 23. The input device 10 connected to the electronic circuit 5 is configured to read the part identification from the information carrier 24 and to forward the part identification to the electronic circuit 5. In the shown third variation, the exchangeable part 23 is a cavity plate comprising multiple cavities attached to a base manifold of the injection mold 1. The information carrier is a RFID tag having stored thereon in addition to the part identification a threshold value for a number of cycles above which a maintenance of the cavity plate is to be made. The input device 10 is implemented as a RFID reader for identifying the cavity plate and receiving the threshold value therefrom. The sensor 3 is implemented as cycle counter. In this setup, the disrupting device is actuated upon a certain exceedance of the threshold value to ensure a maintenance and therewith proper function of the exchangeable part 23.

Rather, the words used in the specification are words of description rather than limitation, and it is understood that various changes may be made without departing from the scope of the disclosure.

### LIST OF DESIGNATIONS

1 Injection mold
2 Injection molding machine
3 Sensor
4 Safeguarding assembly
5 Electronic circuit
6 Disrupting device
7 Housing (electronic circuit)
8 Supply
9 Processor (electronic circuit)
10 Input device
11 Memory (electronic circuit)
12 Communication unit (electronic circuit)
13 Computer system
14 Communication network
15 Visual user interface
16 Location module (electronic circuit)
17 Cable connection box
18 External electronic circuit
19 Actuator
20 Valve
21 User device
22 Gateway
23 Exchangeable part
24 Information carrier

1. An injection mold suitable to be arranged in and during operation interconnected to an injection molding machine for injection molding of plastic parts, the injection mold comprising:
a. at least one sensor;
b. a tamper evident safeguarding assembly for safeguarding of the injection mold comprising
i. an electronic circuit interconnected to the at least one sensor and configured to detect at least one critical injection mold condition based on at least one predetermined condition; and
ii. a disrupting device interconnected to the electronic circuit and configured to at least temporarily directly and/or indirectly disrupt the operation of the Injection mold.

2. The injection mold according to claim 1, wherein the electronic circuit is configured to actuate upon detection of a critical injection mold condition the disrupting device.

3. The injection mold according to claim 1, wherein the electronic circuit is arranged in a housing attached to and/or incorporated in the injection mold.

4. The injection mold according to claim 1, wherein the housing is tamper evident, such that unauthorized access to the electronic circuit is detectable.

5. The injection mold according to claim 1, wherein the disrupting device is configured to self-actuate when disconnected from the electronic circuit.

6. The injection mold according to claim 1, wherein the disrupting device is configured to interrupt a supply of the injection mold, the supply is in particular at least one out of the following: a hydraulic supply, a pneumatic supply, an electrical supply, or a melted plastic supply and the disrupting device is in particular formed as a valve, a switch, or an actuator.

7. The injection mold according to claim 1, wherein the disrupting device is configured to manipulate sensor data transmitted from a sensor arranged in or at the injection mold to a thereto connected external electronic circuit enabling the external electronic circuit based on the manipulated sensor data to at least temporarily prevent operation of the injection mold and/or the injection molding machine.

8. The injection mold according to claim 7, wherein the electronic circuit acts as the disrupting device.

9. The injection mold according to claim 1, wherein the electronic circuit comprises at least one processor configured to determine at least one time interval
a. between receipt of two definable sensor data points; and/or
b. between two or more definable inputs received from an input device connected to the electronic circuit.

10. The injection mold according to claim 1, wherein the electronic circuit comprises
a. at least one memory configured to store at least temporarily
i. sensor data received from the at least one sensor; and/or
ii. at least one time interval; and/or
iii. at least one input value received from an input device connected to the electronic circuit; and/or
iv. a value derived from the sensor data and/or the at least one time interval and/or the at least one input value; or
v. a combination thereof; and
b. at least one processor configured to detect a critical condition of the injection mold based at least partially on data stored in the memory.

11. The injection mold according to claim 10, wherein the at least one memory is configured to store reference data of the at least one predetermined condition, the reference data comprising at least one threshold value and/at least one comparison value; and the at least one processor is configured to determine if at least one out of the following:
a. the sensor data received from the at least one sensor; and/or
b. the at least one time interval; and/or
c. at least one input value received from an input device connected to the electronic circuit; and/or
d. a value derived from the sensor data and/or the at least one time interval and/or the at least one input value; and/or
e. a combination thereof
is above or below the at least one threshold value and/or mismatching with a comparison value, each of the threshold value and the comparison value respectively defining a critical injection mold condition.

12. The injection mold according to claim 1, wherein the electronic circuit comprises at least one communication unit configured
a. to transmit an analysis request comprising data related to at least one condition of the injection mold to a computer system via a communication network, enabling the computer system to obtain an injection mold analysis at least partially based on the data of the analysis request and to transmit the injection mold analysis for display to a visual user interface, the injection mold analysis comprising:
i. at least one condition of the injection mold and/or
ii. at least one key performance indicator (KPI) of the injection mold corresponding to at least one out of the following: a value, a goal, a status, a trend and/or a weight; and/or
b. to receive an analysis response from the computer system via a communication network, the analysis response comprising at least one condition of the injection mold and/or at least one key performance indicator (KPI) of the injection mold and/or instructions for the disrupting device.

13. The injection mold according to claim 9, wherein the at least one processor of the electronic circuit is configured to determine at least one key performance indicator (KPI) of the infection mold from data stored in the at least one memory and to provide the at least one KPI for display to a visual user interface connected to the electronic circuit, wherein the at least one key performance indicator (KPI) of the injection mold corresponds to a value, a goal, a status, a trend, and a weight.

14. The injection mold according to claim 1, wherein the electronic circuit is configured to trigger depending on at least one condition of the injection mold the display of maintenance information on a thereto connected visual user interface.

15. The injection mold according to claim 1, wherein the electronic circuit comprises a location module to determine the location of the injection mold within a production and/or storage area, in particular in relation to the injection molding machine.

16. The injection mold according to claim 1, wherein the housing of the electronic circuit forms part of a cable connection box of the injection mold.

17. The injection mold according to claim 1, wherein the injection mold comprises at least one exchangeable part having a part identification and the electronic circuit being configured to store the part identification of the at least one exchangeable part and to detect at least one critical injection mold condition based on at least one definable critical condition of the at least one exchangeable part.

18. The injection mold according to claim 17, wherein the at least one exchangeable part comprises an information carrier having stored thereon at least the part identification readable by an input device being connected to the electronic circuit, in particular the information carrier having stored thereon additionally at one out of the following: threshold data defining a critical condition of the at least one exchangeable part, historic data relating to the use of the at least one exchangeable part, or molding recipe data therefore.

19. The injection mold according to claim 17, wherein the electronic circuit is configured to determine a critical condition of the at least one exchangeable part based at least partially on data received from the at least one sensor, in particular the data received in the electronic circuit from the at least one sensor relates to at least one out of the following: an operating temperature of the at least one exchangeable part or a cycle count of the injection mold, preferably of the at least one exchangeable part.

20. An injection mold suitable to be arranged in and during operation interconnected to an injection molding machine for injection molding of plastic parts, the injection mold comprising:
a. at least one sensor;
b. a tamper evident safeguarding assembly for safeguarding of the injection mold in an autonomous manner, without a need for external supervision, the safeguarding assembly comprising
i. an electronic circuit interconnected to the at least one sensor and configured to detect at least one critical injection mold condition based on at least one predetermined condition; and
ii. a disrupting device interconnected to the electronic circuit and configured to at least temporarily directly and/or indirectly disrupt the operation of the injection mold.
